(19) United States
(12) Patent Application Publication
(10) Pub. No.: US 2008/0166460 A1
(43) Pub. Date: Jul. 10, 2008

(54) Methods and Apparatus for Processing Perishable Products

(75) Inventor: Roger Keith Palmer, Auckland (NZ)

Correspondence Address: BIRCH STEWART KOLASCH & BIRCH, PO BOX 747, FALLS CHURCH, VA, 22040-0747, US

(73) Assignee: FOODCAP INTERNATIONAL LIMITED, Auckland (NZ)

(21) Appl. No.: 11/665,620

(22) PCT Filed: Oct. 17, 2005
(86) PCT No.: PCT/NZ2005/000275

§ 371 Date: Dec. 7, 2007

(30) Foreign Application Priority Data
Oct. 18, 2004 (NZ) 536034

(51) Int. Cl. A23L 1/48; A47J 44/00; B65D 85/00

(52) U.S. Cl. 426/389; 99/485; 99/467; 99/484; 426/392; 426/416

(57) ABSTRACT

A centralised cabinet ready processing system for perishable food products such as meat includes containers (50) that are used in conjunction with processing devices including a lid (56), a gassing apparatus (58), trays (82), compression apparatus (72, 74), and internal cooling apparatus (70) to treat the food product dependent on the food product type. An inventory (1), transport system (2, 20, 22) and control system are also provided to allow efficient and safe handling of food products to achieve processing.

### FIELD OF THE INVENTION

This invention relates to processing of perishable food products. The invention has particular application to processing meat, and to centralised or cabinet ready meat processing systems.

Throughout this specification it is to be understood that references to “meat” include all forms of meat of all descriptions generally considered to be edible, for example including without limitation fish, beef, pork, lamb, poultry and offal.

### BACKGROUND

Meat is usually processed for retail sale at the retail outlet where it is sold. The processing typically takes the form of carcasses or meat primals being supplied to the retail outlet and then being processed at that outlet to provide the retail product which is then packaged, labelled and placed in display cabinets. The term “meat primal” refers to meat post slaughter but prior to retail processing. Typically this will refer to meat which has been principally deboned, and could include muscle portions as well as large quantities of mince, for example. Once meat has been processed and is ready for display in retail cabinets, it is usually referred to as being “cabinet ready”.

In the case of meat primals, these are usually vacuum packed in plastic bags post slaughter and then packaged into cardboard boxes. The cardboard boxes are in turn palletised and warehoused in a chiller in the palletised form to be aged. However is not possible to bring cartons into the production area because they cannot be made sterile, so the vacuum packed bags must be unpacked from the carton prior to entry into the processing area. Similarly, the meat must be unpacked from the vacuum packs or other consumable packaging prior to entry into the production area. Therefore, existing systems are labour intensive, wasteful and environmentally unfriendly. These systems also pose hygiene risks.

### SUMMARY OF INVENTION

It is an object of the present invention to provide improved processing methods and/or apparatus for perishable food products such as meat.

Alternatively, or additionally it is an object of the invention to provide processing apparatus and/or methods for perishable food products such as meat which ameliorate one or more disadvantages of known methods or apparatus, or which will at least provide the public with a useful choice.

Accordingly in one aspect the invention broadly consists in a method of processing or storing a perishable food product, the method comprising

providing a liddable container having a handling means provided on an external surface thereof to allow automated handling of the container,
providing access to processing devices including a lid, a gassing means, a tray means, a compression means, and an internal cooling means,
receiving one or more perishable products, and
containerising the product in the container in conjunction with one or more of the processing devices dependent on a property of the product.

Preferably the product comprises a meat primal.

Preferably the gassing means comprises an apparatus for varying the atmosphere within the container.

Preferably the tray means comprises one or more shelves or trays arranged to carry products within the container.

Preferably the compression means comprises one or more platens that may be arranged to apply mechanical compression to the product within the container.

Preferably the cooling means comprises apparatus containing a coolant that may be placed within the container to cool the product in the container.

Preferably a plurality of clips are provided for affixing the lid to the container.

Preferably a plurality of containers are provided.

In a second aspect the invention broadly consists in apparatus for processing or storing a perishable food product, the apparatus comprising

a liddable container having a handling means provided on an external surface thereof to allow automated handling of the container, and
a plurality of processing devices including a lid, a gassing means, a tray means, a compression means, and an internal cooling means.

Preferably the product comprises a meat primal.

Preferably the gassing means comprises an apparatus for varying the atmosphere within the container.

Preferably the tray means comprises one or more shelves or trays arranged to carry products within the container.

Preferably the compression means comprises one or more platens that may be arranged to apply mechanical compression to the product within the container.

Preferably the cooling means comprises apparatus containing a coolant that may be placed within the container to cool the product in the container.

Preferably a plurality of clips are provided for affixing the lid to the container.

In a third aspect the invention broadly consists in a centralised meat processing method comprising the steps of

providing a plurality of reusable containers,
placing a meat product production ingredient in each container and storing the containers in an inventory,
selecting at least one container,
retrieving the container from the inventory,
removing the ingredient from the container,
using the ingredient in a processing operation,
returning any unused ingredient to the container, and
returning the container to the inventory.

Preferably the step of retrieving the container or returning the container to the inventory includes conveying the container on a conveyor.

Preferably the step of retrieving the container or returning the container to the inventory includes automatedly transporting the container to or from a predetermined location in the inventory.

Preferably the ingredient comprises a meat cut.

In a second aspect the invention broadly consists in a centralised meat processing method comprising the steps of

providing a plurality of reusable containers,
placing a meat product production ingredient in each container and storing the containers in an inventory,
selecting at least one container,
retrieving the selected container from the inventory,
removing the ingredient from the selected container,
using the ingredient in a meat processing operation,
placing by-products or semi-finished products of the meat processing operation in a container, and
placing the container in the inventory.

In a third aspect the invention broadly consists in a meat processing method comprising the steps of

containerising and storing a plurality of ingredients that may be used to produce one or more retail meat products,
selecting a product to be produced,
providing a list of required ingredients required to produce the selected product,
placing a request for delivery of each required ingredient to a production area,
selecting one or more containers in which the required ingredients are stored,
delivering the selected containers to the production area.

Preferably the one or more containers is selected dependent on the time for which the ingredient or ingredients it contains has been stored.

In a fourth aspect the invention broadly consists in meat processing apparatus comprising:

a post slaughter meat processing inventory having a plurality of container support structures adapted to support containers containing at least one meat processing ingredient;
a production apparatus for production of retail meat products using the one or more ingredients stored in the containers;
container transport means to transport the containers between the shelves and the production apparatus; and
control means to receive a delivery request for an ingredient, select a container containing the ingredient, and cause the container transport means to transport the selected container to, or adjacent to, the production apparatus in response to the delivery request.

Preferably the control means can receive a return request that a container be returned to the chiller, and cause the container transport means to return the container to the inventory in response to the return request.

Preferably the production apparatus comprises a plurality of production cells.

Preferably the control means selects the container dependent on the time for which the ingredient held by the container has been stored in the inventory.

Preferably the apparatus includes an unloading means to unload the ingredient from the container to the production apparatus.

Preferably the containers are reusable rigid containers.

The invention also broadly consists in any new feature or combination of features disclosed herein.

### DRAWING DESCRIPTION

One or more embodiments of the invention will be described below by way of example with reference to the accompanying drawings, in which:

FIG. 1 is a schematic plain view of a meat production facility,

FIG. 2 is a perspective view of a container,

FIG. 3 is a perspective view of a compression and/or cooling device for use with the container of FIG. 2,

FIG. 4 is a perspective view of a shelving unit for use with the container of FIG. 2

FIG. 5 is a schematic plan view of a production cell,

FIG. 6 is a flow chart illustrating a production process, and

FIG. 7 is a diagrammatic elevation in cross section of gas transfer or flushing apparatus.

### DETAILED DESCRIPTION

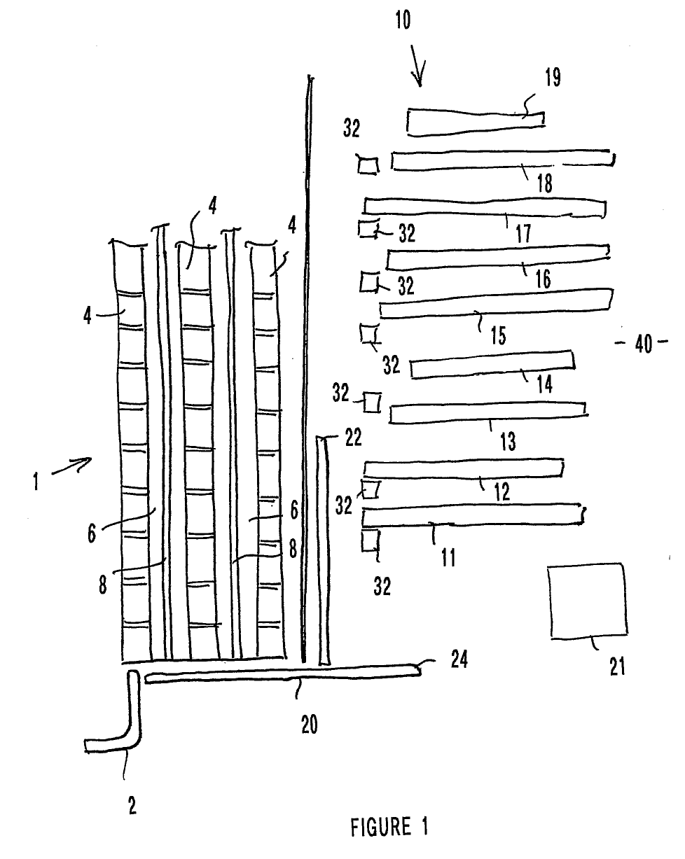

Referring to FIG. 1, a schematic outline diagram of a part of a centralized meat processing facility is shown. Such a facility provides cabinet ready meat products from ingredients which will usually include meat primals. Although the facility and associated production processes will be described with reference to processing and distribution of meat products, it will be seen by those skilled in the art that the invention may be applicable to distribution and/or processing of a variety of other perishable food products including without limitation agricultural or horticultural produce (both edible or inedible), natural and semi-processed food products and organic products generally. The process also has general application to products in which a controlled atmosphere or at least controlled temperature conditions is desirable or necessary for ensuring product quality or longevity.

In FIG. 1, an inventory 1 preferably having a controlled temperature environment to retard or minmise bacterial growth, is provided in which the perishable ingredients, such as meat primals are stored and cooled if necessary. The ingredients are placed in rigid reusable containers which are transported to the inventory 1 where they are stored. The filled containers are preferably introduced, put away and retrieved to and from the inventory 1 by automated means such as conveyor system 2, 20 or 22 in response to requests to, and instructions from, control system 21. In a preferred embodiment the control system 21 comprises computerized apparatus including a database and interfaces to the various machinery and user displays. The inventory 1 has one or more container carrying or support structures, each having a plurality of racks or shelves 4 on which containers are placed. These are preferably arranged in rows leaving aisles 6 in between the rows of shelves 4 in which an automated transport device, such as a crane (not shown) may move, for example along rails 8. The structures are also preferably constructed or arranged to provide spaces between containers to allow air circulation between containers. In a preferred embodiment the transport apparatus is automated, using a control system whereby the crane is moved to a predetermined location along each of the aisles 6, and then moves loading forks, or similar loading apparatus, to a required rack or shelf to remove or deliver a container to the required rack or shelf location.

The containers contain ingredients for meat processing. As mentioned above, these ingredients will primarily be meat primals. However, certain containers will contain other ingredients that may be used in a meat processing operation, for example breadcrumbs, batter, curing ingredients, marinades, sausage ingredients and casings, seasoning, by-products such as purge and trim and semi-finished goods.

The container in which the ingredients are placed may be the same as or similar to that described in our granted U.S. Pat. Nos. 5,670,195 and 6,194,012, the contents of which are incorporated herein by reference in their entirety. The container is sealed following introduction of the meat or other ingredient and preferably has a unique identifier associated with it. In the preferred embodiment the identifier is provided by applying an RFID (Radio Frequency Identification) tag to the container. However other methods may be used, for example applying a bar code or a label.

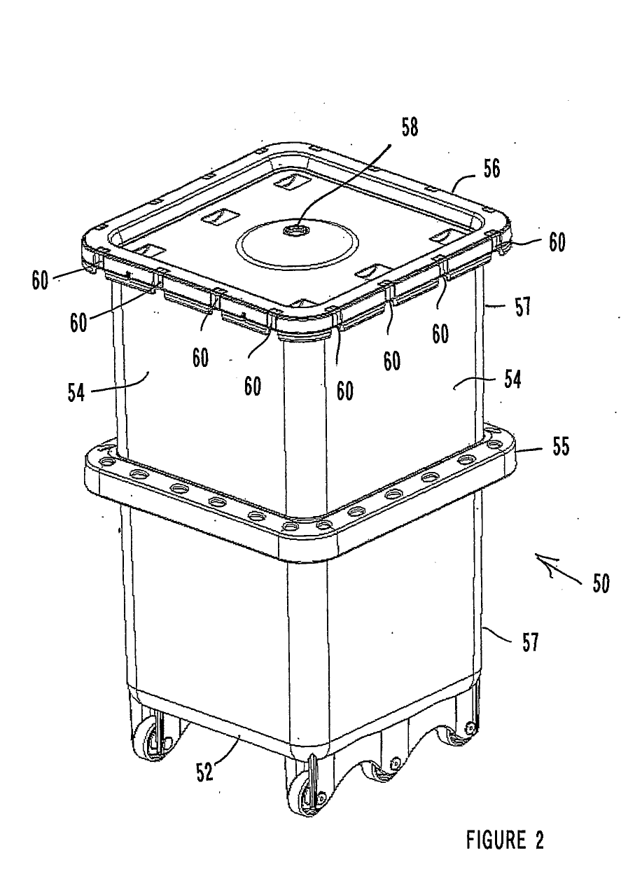

A preferred form of container is shown in FIG. 2. Referring to that Figure, the container 50 includes a base 52, one or more side walls (in this example four side walls are shown) 54, and a lid 56. The container has standardized external dimensions which provide a means for handling so as to allow automated handling of the container. Thus an external rib 55 provides a collar which may be used by lifting and transport apparatus, such as the crane referred to above, to engage with the collar and handle the container. Since the external dimensions of the container are standardized, the handling apparatus may handle all the containers in the inventory. The containers wall(s) may also include a taper 57 to allow one container to be stacked within another. The taper may also facilitate automated handling.

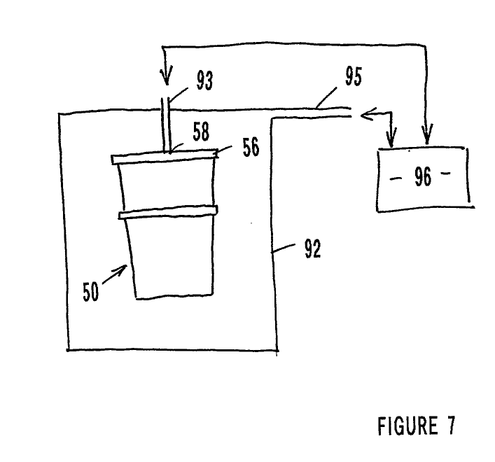

A valve 58 is provided in the lid of each container. Once sealed, the atmosphere within each container may be modified or pressurized, for example by using the valve in conjunction with a vacuum source and/or supply of a desired gas or combination of gasses to evacuate the air within the container surrounding the ingredients and replace it with a desired gas (such as carbon dioxide in the preferred embodiment of the meat processing example) or a desired combination of gases. In a preferred embodiment, the atmosphere within the container is an anaerobic atmosphere. This may be achieved by flushing the container with one or more gases, such as carbon dioxide for example. Turning to FIG. 7, apparatus for effecting the gas flushing process is diagrammatically illustrated. The container 50 is placed in a substantially fluid tight enclosure 92. A fluid communication device 93 may be engaged with the valve 58 that is provided in the lid 56 of the container such that a vacuum may be drawn within the container from a vacuum source which may be connected to apparatus 93, and a selected gas or mixture of cases may be introduced into the container through the apparatus 93. The enclosure 92 has a fluid passageway 95 which may also be connected to a source of positive or negative pressure. Controller 96 controls the vacuum source and gas supply provided to apparatus 93 and passageway 95 to effect the gas transfer and to adjust the pressure of the atmosphere within enclosure 92 to substantially match the pressure of the atmosphere within the container 50.

The lid may be affixed to the container by clips 60 which have a general “U” shape with one leg of the “U” engaging with the container rim and the other with the lid. The clips allow the lid to be maintained in sealing contact with the container to provide a fluid tight seal, thereby maintaining the desired atmosphere and/or pressurization within the container. The clips also facilitate a mechanical connection between the container body and the lid which assists with the overall structural integrity of the container.

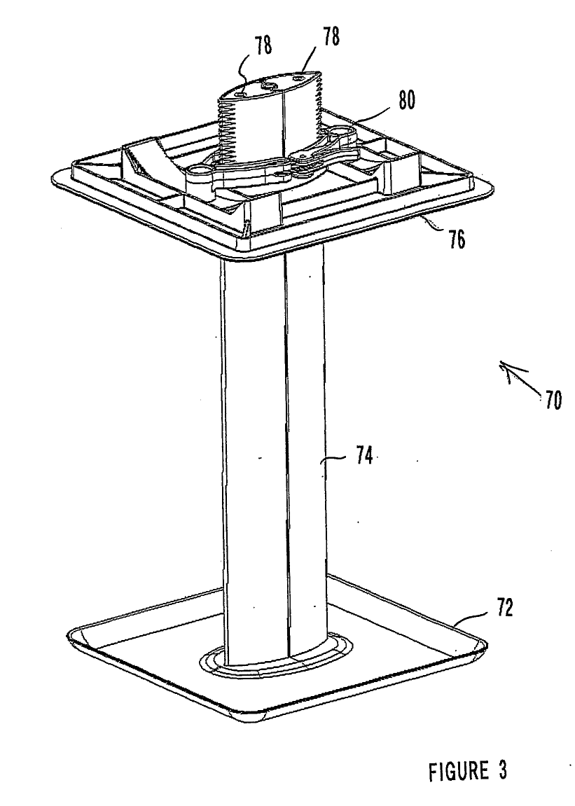

Referring to FIG. 3, compression and/or cooling apparatus 70 may be provided in the container. Thus, if the ingredient is deboned beef primals, then these may be placed between platens 72 and 74. Mechanical compression is applied to the primals by placing downward pressure on platen 76 and engaging it with central stem 74 using the platen engagement mechanism 80. The engagement mechanism 80 may include a biasing mechanism such as a spring to ensure that pressure is maintained on the primals. Alternatively, or in addition, the stem 74 can provide a cooling function. The stem includes a cavity which may be accessed through apertures 78 to allow a coolant such as water to be provided in the cavity and frozen to form ice. As the ice melts following placement of primals in the container about the stem, significant heat energy is drawn from the primals, melting the ice and lowering the temperature of the primals.

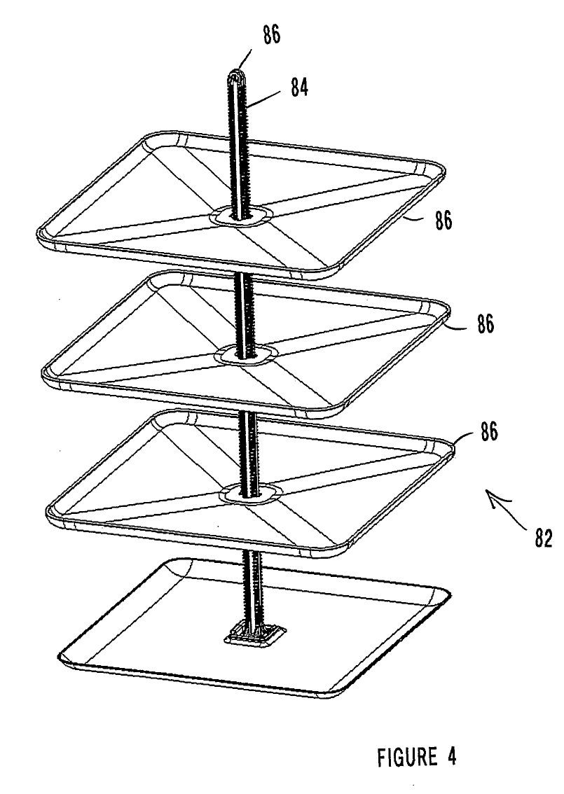

Referring now to FIG. 4, a series of removable, height adjustable shelves 82 may be provided within the container for storing bone in cuts or other ingredients. The shelves are adjustably moveable relative to a central support 84 which has a lifting eye 86 to allow a loading or unloading mechanism to lower or lift the shelf unit into or out of the container. The shelves 82 include a contoured central aperture that allows each shelf to be selectively engageable with teeth on the support 84. The shelves engage with the support 84 in one angular disposition, and may be disengaged by rotation (for example through approximately 45 degrees) upon which they may be moved along the support.

Therefore, when ingredients are placed in containers, the user has a number of options for storage or treatment of the ingredients as part of the overall processing. The processing apparatus or components identified above allow the best storage conditions to be utilized for that particular ingredient so as to maximize the quality and/or condition of the perishable product. For example, if poultry primals are to be placed in the container, then these will typically be placed in the container, and the container will simply be lidded. If beef primals are supplied, then these will typically be maintained under mechanical pressure, and the internal cooling apparatus will be used to reduce their temperature. The container will typically be gassed with a gas mixture to reduce microbial growth, and pressurized. Bone-in beef primals will typically be placed on shelves within the container, and lidded, then gassed, and pressurized. Other ingredients may also be placed on shelves, and some may not require lidding of the container.

Once filled with the desired ingredient or ingredients, the containers are placed in the inventory. If the ingredient is certain meats, for example beef primals, then the container may be retained in the inventory for a certain period of time to allowing ageing of the meat prior to processing while keeping bacterial growth to a minimum. For example, beef may typically be aged from five to seven days before it reaches a retail shelf. The time period for which the meat is aged will vary depending upon the number of factors such as the meat type and the cut type for example.

The location, “age” and identity of the ingredient(s) in each container is recorded and associated with the identity of the container in a database. In this way the system knows when a container can or should be removed from the chiller, and where to locate it so that the moving operation can be performed efficiently.

Once the meat cuts have aged, the containers are transported to a production area generally referenced 10 which has at least one production cell consisting of one or more machines sequentially arranged to produce one or more products from the ingredients provided in the containers. In example shown nine production cells (referenced 11 through 19) are provided. In a preferred embodiment, a dedicated production line is provided for each primary product, for example bone in, roasts, sliced, mince, diced/strips, crumbing, sausage, chicken.

Further conveyor apparatus 20 allows containers to be transported from the primal chiller to the production area team. The conveyor apparatus 20 interfaces with the transport apparatus in the primal chiller 1. A control system (not shown, but which in the preferred embodiment comprises a computerized system capable of receiving requests and transmitting instructions electronically or wirelessly) is provided whereby a request may be made in the production area for one or more containers or ingredients to be retrieved from the primal chiller. Once the request has been received, the control system instructs the transport apparatus within the primal chiller, and the conveyor apparatus 20, to select and retrieve one or more containers containing the requested ingredients and deliver those containers to the production area 10. In the example shown, the conveyor apparatus 20 discharges the containers to the production area at or about end 22 of the conveyor assembly. However, the conveyor apparatus 20 may be configured to convey the container directly to the selected production cell. Furthermore, conveyor apparatus 20 has a further delivery or entry point 24. This may be used to discharge used containers so that those containers may undergo a cleaning and sterilisation process. Delivery or entry point 24 may also be used to deliver cleaned and sterilised containers to the production area so that these containers may be used to contain semi-finished products, by-products or unused ingredients, as will be described further below.

Referring now to FIG. 5, a typical production cell is schematically illustrated in plan view. The production flow path through the cell is in the direction illustrated by arrow 30. A container of a desired ingredient is directed to an unloading device 32. Before or upon reaching the unloading device the container is de-lidded and the purge (if the ingredient is meat) is removed. The unloading device lifts and/or rotates the container in such a way that the contents of the container are emptied under gravity for processing through processing apparatus 34. However, with some ingredients, such as seasoning for example, the required quantity of the ingredient may be removed without tipping the container. Processing may typically include manual or automated cutting of meat primals and/or combining meat ingredients with other ingredients. Before or after processing has been completed, apparatus 35 de-nests retail trays to allow the retail products to be placed on the trays after which the products are buffered by a buffer conveyor 36 for provision to a wrapping machine 37. The wrapped retail products are then buffered again on another buffer conveyor 38 to be conveyed for accumulation in a buffer chiller which is generally referenced 40 in FIG. 1.

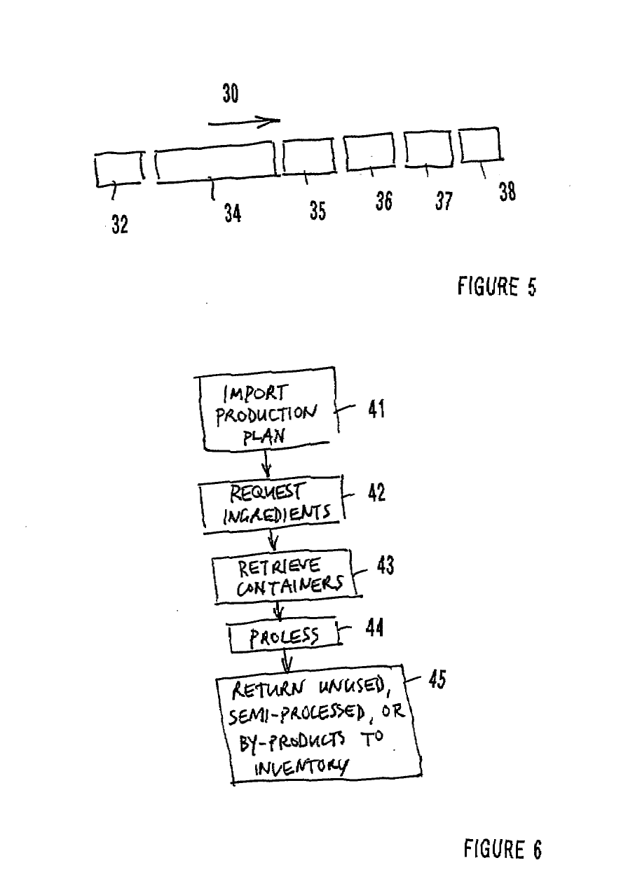

By way of example, a production process may be described with reference to the flow chart shown in FIG. 6. Referring to that Figure, the process begins in step 41 in which a production plan is imported from an enterprise resource planning system associated with the production facility. The plan is imported into the control system 21 in such a way that each production cell receives and displays a manufacturing schedule for the operator(s) of the cell. Based on the manufacturing schedule, the operator requests containers of the required ingredients. This occurs in step 42. In this step the operator also preferably requests a certain number of empty containers for excess or unused products and by-products which result from the process. In step 43, the control system retrieves the required ingredients by selecting the containers. The selection process is dependent on a number of rules which are provided to the control system. For example, most of the primal meat cuts in the chiller 1 need to be aged for a predetermined period of time (for example five to seven days in the case of beef) before being processed. Therefore, the control system will select a container which meets the required time period, and which contains the required ingredients that were requested. The control system then ensures that the containers are delivered to the production area (and/or directly to the required production cell).

In step 43 the containers containing the primary ingredient are unloaded at each cell using the unloading device. In step 44 the processing takes place. Each production cell has an interactive screen which can display information such as the production schedule for that cell, product specifications, pack counts, machine set-up, changeover and operating requirements, washing procedures and maintenance instructions and warning information such as jams, failures etc. As described above, processing preferably includes providing a cabinet ready retail product. The product may be labeled, but in the preferred embodiment, the product is provided to the buffer chiller for storage awaiting a retail order in an unlabelled state. In this way, labelling may be completed depending upon retailer's requirements once the retail order has been received.

The production of retail ready products involves a significant amount of byproducts which are incorporated into other products such as sausages, as well as products which require further processing, such as crumbing or marinating etc. Where these are not required immediately (or where it is more efficient to process them at a later time they are returned to inventory for), further processing at a subsequent time. This occurs in step 45.

Throughout the process, variables such as processing, changeover times and yields are automatically recorded using the control system for efficiency and financial analysis through the enterprise resource planning system. This enables the system to optimise the production schedules, cell equipment and procedures over time to maximise productivity. Information used may further include machine operating speeds, product set up and changeover times, washing times, and interface constraints such as primal chiller, accumulator put away, retrieval and capacity, sorting.

The invention allows individual production cells to provide a range of different products from different ingredients, so that from a multitude of different primal cuts of beef, pork, lame and chicken for example, nine or ten production cell is may well produce over 400 different product lines (SKU's) of retail or cabinet ready product. The system allows practical hygiene requirements to be addressed for each change of species and/or type of primal cuts such as wash downs and machine set up procedures.

Since the ingredients involved in meat production processes are perishable, the containerisation system allows these to be efficiently and hygienically handled and be housed in a controlled temperature (and/or a controlled atmosphere) environment. This provides operating efficiencies. Furthermore, the ability to automatically transport the containers provides increased efficiencies and allows just-in-time delivery to the production cells using a single materials handling system.

Where in the foregoing description reference has been made to specific components or integers of the invention having no equivalents, then such equivalents are herein incorporated as if individually set forth.

The word “comprising” and variants thereof is intended to be interpreted in an inclusive sense.

Although this invention has been described by way of example and with reference to possible embodiments thereof, it is to be understood that modifications or improvements may be made thereto without departing from the scope of the invention.

1-26. (canceled)

27. Apparatus for processing meat primals, the apparatus comprising
a liddable container having a handling means provided on an external surface thereof to allow automated handling of the container, and
a plurality of processing devices including a lid, a gassing means, a tray means, a compression means, and an internal cooling means.

28. Apparatus as claimed in claim 27 wherein the gassing means comprises an apparatus for varying the atmosphere within the container.

29. Apparatus as claimed in claim 27 wherein the tray means comprises one or more shelves or trays arranged to carry products within the container.

30. Apparatus as claimed in claim 27 wherein the compression means comprises one or more platens that may be arranged to apply mechanical compression to the product within the container.

31. Apparatus as claimed in claim 27 wherein the cooling means comprises apparatus containing a coolant that may be placed within the container to cool the product in the container.

32. Apparatus as claimed in claim 27 wherein a plurality of clips are provided for affixing the lid to the container.

33. A method of processing meat primals, the method comprising
providing a liddable container having a handling means provided on an external surface thereof to allow automated handling of the container,
providing processing devices including a lid, a gassing means, a tray means, a compression means, and an internal cooling means,
receiving the meat primals, and
containerising the primals in the container in conjunction with one or more of the processing devices dependent on a property of the primals.

34. A method as claimed in claim 33 including providing a plurality of containers.

35. A method for centralised processing of meat primals, the method comprising the steps of
providing a plurality of reusable containers,
placing a meat product production ingredient in each container and storing the containers in an inventory,
selecting at least one container,
retrieving the container from the inventory,
removing the ingredient from the container,
using the ingredient in a processing operation,
returning any unused ingredient to the container, and
returning the container to the inventory.

36. A method as claimed in claim 35 wherein the step of retrieving the container or returning the container to the inventory includes conveying the container on a conveyor.

37. A method as claimed in claim 35 wherein the step of retrieving the container or returning the container to the inventory includes automatedly transporting the container to or from a predetermined location in the inventory.

38. A method as claimed in claim 35 wherein the ingredient comprises a meat cut.

39. A method for centralised processing of meat primals, the method comprising the steps of
providing a plurality of reusable containers,
placing a meat product production ingredient in each container and storing the containers in an inventory,
selecting at least one container,
retrieving the selected container from the inventory,
removing the ingredient from the selected container,
using the ingredient in a meat processing operation,
placing by-products or semi-finished products of the meat processing operation in a container, and
placing the container in the inventory.

40. A method for processing meat primals, the method comprising the steps of
containerising and storing a plurality of ingredients that may be used to produce one or more retail meat products,
selecting a product to be produced,
providing a list of required ingredients required to produce the selected product,
placing a request for delivery of each required ingredient to a production area,
selecting one or more containers in which the required ingredients are stored,
delivering the selected containers to the production area.

41. A method as claimed in claim 40 wherein the one or more containers is selected dependent on the time for which the ingredient or ingredients it contains has been stored.

42. Apparatus for processing meat primals, the apparatus comprising:
a post slaughter meat processing inventory having a plurality of container support structures adapted to support containers containing at least one meat processing ingredient;
a production apparatus for production of retail meat products using the one or more ingredients stored in the containers;
container transport means to transport the containers between the shelves and the production apparatus; and
control means to receive a delivery request for an ingredient, select a container containing the ingredient, and cause the container transport means to transport the selected container to, or adjacent to, the production apparatus in response to the delivery request.

43. Apparatus as claimed in claim 42 wherein the control means can receive a return request that a container be returned to the chiller, and cause the container transport means to return the container to the inventory in response to the return request.

44. Apparatus as claimed in claim 42 wherein the production apparatus comprises a plurality of production cells.

45. Apparatus as claimed in claim 42 wherein the control means selects the container dependent on the time for which the ingredient held by the container has been stored in the inventory.

46. Apparatus as claimed in claim 42 including an unloading means to unload the ingredient from the container to the production apparatus.

47. Apparatus as claimed in claim 42 wherein the containers are reusable rigid containers.
